(19) United States
(12) Patent Application Publication
(10) Pub. No.: US 2008/0092745 A1
(43) Pub. Date: Apr. 24, 2008

(54) AIR FILTER WITH AUTOMATIC POWER CONTROL DEVICE IN RESPONSE TO AIR QUALITY

(76) Inventors: Hung-Ta TSAO, Taipei (TW); Li-Chung Huang, Taipei (TW); Min-Hui Chiang, Taipei (TW)

Correspondence Address: LEONG C LEI, PMB # 1008, 1867 YGNACIO VALLEY ROAD, WALNUT CREEK, CA, 94598, US

(21) Appl. No.: 11/550,411

(22) Filed: Oct. 18, 2006

(51) Int. Cl. B01D 46/00

(52) U.S. Cl. 96/224

(57) ABSTRACT

A cabinet-shaped AIR FILTER includes an air inlet in a lower casing, an air outlet in an upper casing, an air quality measurement and power control device, a fan behind the air inlet, a housing for enclosing the fan and having two sidewalls formed with the lower casing, the housing including a front air intake of streamline section, an upper air exit of rectangular section, and a board extended forward from a top of the air exit to a joining side of the upper and lower casings, one or more ultraviolet lamps on the top of the air exit, and a deodorant and dust filter in the upper casing. The fan can automatically operate in one of different stages in response to different levels of air quality measured by the air quality measurement and power control device.

### BACKGROUND OF THE INVENTION

(a) Technical Field of the Invention

The invention relates to air filters and more particularly to an air filter having an air quality measurement and power control device adapted to automatically regulate its power in response to different levels of air quality being measured.

(b) Description of the Prior Art

The airborne transmission of disease organisms has long been recognized as a serious problem. For removing contaminants such as dust, pollen, mold, and bacteria from air, a great variety of air filters are commercially available.

One conventional type of AIR FILTER is enclosed in a cabinet. Within the cabinet there are provided an air inlet, a purifying filter, an open fan, a deodorant and dust filter, and an air outlet. The filters and the fan are arranged along a transverse air filtering path. Thus, the air filter has a relatively large size. It not only occupies a large space but also is visually unattractive.

Another conventional type of AIR FILTER is designed based on the concept of “Fan Coil Unit” in which the deodorant and dust filter is installed above the fan such that the air filter can be produced thinner. In detail, a board is provided to divide space of the cabinet into a lower casing and an upper casing. The board is connected to an air guide. The air guide is adapted to guide sucked air to the fan. Next, air is blown to the air outlet by the activating fan. However, it is found that there are gaps between the air guide and the board and between the air guide and the cabinet. Thus, air may leak from the gaps. This in turn increases air friction and causes adverse short air cycles within the cabinet. Also, only one side of the fan is secured to the cabinet. Thus, the fan may vibrate strongly during operation. Further, the fan can generate great noise during operation due to no enclosing housing. Moreover, air may leak from rear gaps of the cabinet prior to purification. Thus, its purification effect is low.

Still another conventional type of AIR FILTER further comprises a lamp for destructing airborne microorganisms. While it is effective for the removal of solid particles, it lacks the capability of automatically regulating its power in response to air quality. Thus, the well-known air filters are disadvantageous for always operating in high power even when air quality has been improved after a period of time of operation. That is, they are not power-saving devices. Thus, the need for improvement still exists.

### SUMMARY OF THE INVENTION

The primary purpose of the present invention is to provide an air filter having an air quality measurement and power control device adapted to automatically regulate its power in response to different levels of air quality being measured.

To achieve the above and other objects, the present invention provides an air filtering device comprising a cabinet substantially divided into a lower casing and an upper casing air inlet means mounted in the lower casing and having one or more openings; air outlet means mounted in the upper casing and having one or more openings; air quality measurement and power control means; an electric fan mounted in a rear of the air inlet means and controlled by the air quality measurement and power control means; a housing in the lower casing for enclosing the fan and having two sidewalls formed with the sides of the lower casing, the housing including an air intake of streamline section mounted on a front face of the housing, an air exit of rectangular section mounted on an upper portion of the housing, and a top board extended forward from a top of the air exit to a joining side of the upper and lower casings; one or more ultraviolet lamps mounted on the top of the air exit; and a deodorant and dust filter mounted in the upper casing, wherein the fan is adapted to automatically operate in one of a plurality of different stages in response to different levels of air quality measured by the air quality measurement and power control means.

In a first aspect of the present invention the purifying filter is removable and is made of photocatalytic materials, active carbon material, or the like.

In a second aspect of the present invention the air quality measurement and power control means is either a gas sensor or a particle sensor.

In a third aspect of the present invention the control panel includes a display for showing operating states of the components, air quality, air volume, etc.

In a fourth aspect of the present invention there is further provided a control panel mounted on the cabinet, and an electric sliding cover having both sides fitted in two parallel grooves of the cabinet, the sliding cover adapted to either close the control panel in an inoperative condition for the purpose of preventing dust or the like from entering into the control panel or open same in an operating condition.

In a fifth aspect of the present invention each opening of each of the air inlet means and the air outlet means has an electric louver.

In a sixth aspect of the present invention there is further provided a far infrared heater mounted in the air outlet means.

In a seven aspect of the present invention there is further provided an aroma atomization member mounted on a top of the air outlet means, the aroma atomization member adapted to atomize liquid aroma contained therein and shoot out a fine spray into the air.

In an eighth aspect of the present invention there are further provided two or more wheels mounted on a bottom of the cabinet.

In a ninth aspect of the present invention there are further provided a plurality of brackets on the back of the cabinet so as to mount the cabinet on a wall or a ceiling.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of AIR FILTER according to the invention;

FIG. 2 is another perspective view of the AIR FILTER where the sliding cover has been removed;

FIG. 3 is a longitudinal sectional view of FIG. 1 for showing an air filtering path of the air filter;

FIG. 4 is a side elevation of the air filter for showing its mounting on a wall;

FIG. 5 is a perspective view of a mechanism for actuating the sliding cover;

FIG. 6 is a perspective view of the louver;

FIG. 7 is a view similar to FIG. 6 where the louver is in an open state; and

FIG. 8 is a view similar to FIG. 6 where the louver is in a closed state.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

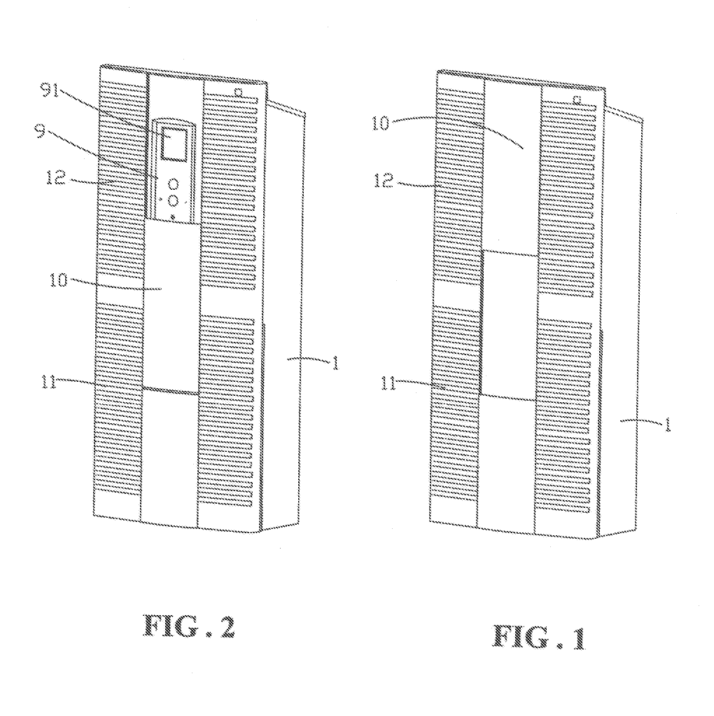

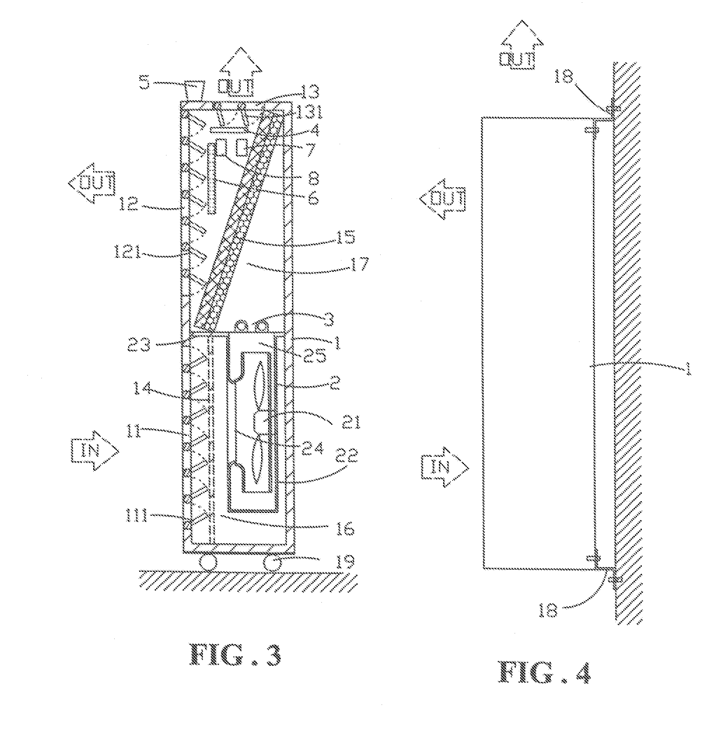

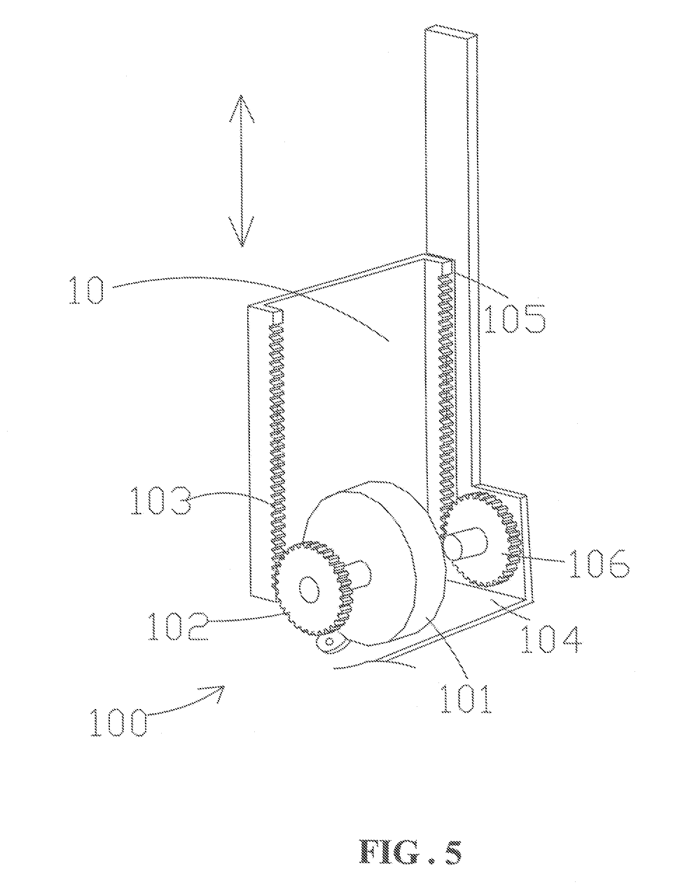

Referring to FIGS. 1 to 8, an air filter in accordance with a preferred embodiment of the present invention is shown. The AIR FILTER is enclosed in a cabinet 1 substantially divided into a lower casing 16 and an upper half casing 17. In one configuration the cabinet 1 is mounted with four wheels 19 at four bottom corners for facilitating transportation (see FIG. 3). In another configuration the cabinet 1 is provided with a plurality of brackets 18 adapted to mount on a wall (see FIG. 4).

Two lower air inlets 11 are provided on two sides of a front surface of the lower half casing 16. A louver 111 is provided in either air inlet 11, the louver 111 having a series of adjustable sloping slats. Two upper first air outlets 12 are provided on two sides of a front surface of the upper half casing 17. A second air outlet 13 is provided on a top surface of the upper half casing 17. Each of the first and second air outlets 12 and 13 has a louver 121 or 131 having a series of automatically adjustable sloping slats.

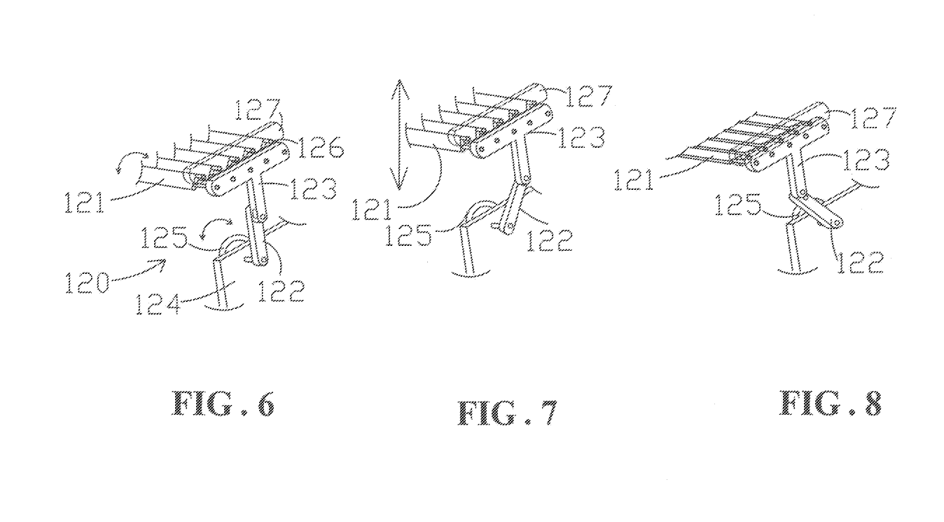

Referring to FIGS. 6 to 8 specifically, the opening or closing of the louvers 121 and 131 is done electrically. In detail, as shown, the louver 121 is driven by a first drive assembly 120. The first drive assembly 120 comprises an electric motor 125 mounted on a board 124 in the cabinet 1, the motor 125 adapted to rotate clockwise or counterclockwise, a link 122 having one end pivotably connected to the rotating shaft of the motor 125, and a T-shaped member 123 having one end of its intermediate portion pivotably connected to the other end of the link 122. The sloping slats of the louver 121 have both ends formed with two plates 127 respectively. Also, a pivotal shaft 126 is formed at one end of each sloping slat of the louver 121. The shaft 126 has its open end pivotably disposed in each of a plurality of shaft passages formed in the base portion of the T-shaped member 123. In operation, for example, a clockwise rotation of the motor 125 can open the louver 121 or a counterclockwise rotation of the motor 125 can close the louver 121 through the above pivotal mechanisms. Alternatively, the opening or closing of the louvers 121 and 131 can be done manually in other embodiments.

Within the lower half casing 16 there are provided a removable purifying filter (e.g., one made of photocatalytic material, active carbon material, or the like) 14 in a rear of the air inlet 11, and a drive mechanism 2 in a rear of the purifying filter 14. The drive mechanism 2 comprises an electric motor 21, a housing 22 having two sidewalls formed with the sides of the lower half casing 16 for enclosing the motor 21 therein so as to reduce noise and vibration caused by the motor 21 in operation, an air intake 24 of streamline section provided on a front face of the housing 22, an air exit 25 of rectangular section provided on an upper portion of the housing 22, and a top board 23 extended forward from the top of the air exit 25 to a joining side of the upper and lower half casings 16 and 17. Two ultraviolet lamps 3 are provided on the top of the air exit 25 and are adapted to emit ultraviolet radiation to destruct bacteria, viruses, and microorganisms in the air. Moreover, air traveling between the air intake 24 and the upper half casing 17 is in an enclosed air filtering path in the drive mechanism 2. Thus, it can prevent air from leaking out of joining portions of the components in the cabinet 1. As a result, well known adverse short air cycles within the cabinet 1 are avoided.

On a front face of the upper half casing 17 there are provided a control panel 9 between the first air outlets 12, the control panel 9 having a display 91 for showing operating states, and an electric sliding cover 10 on the control panel 9 adapted to either close the control panel 25 in an inoperative condition or open same in an operating condition. The sliding cover 10 has a section of U and has a toothed section 103 formed on an open end at either side. Both sides of the sliding cover 10 are fitted in two parallel grooves 105 on a portion between upper first air outlets 12. The sliding cover 10 is driven by a second drive assembly 100 mounted on a bracket 104 in a rear of the sliding cover 10. The second drive assembly 100 comprises an electric motor 101 and two gears 102 and 106 spaced from both sides of the motor 101 and rotatably driven by the rotating shaft of the motor 101. The gears 102 and 106 are in mesh engagement with the toothed sections 103 respectively. Thus, the second drive assembly 100 is adapted to electrically lower or raise the sliding cover 10 for opening or closing same.

Within the upper half casing 17 there are provided the following components. An inclined deodorant and dust filter 15 is provided from a rear top corner to a front bottom corner to be supported by the top board 23. An aroma atomization member 5 contained with liquid aroma is provided on a top of the second air outlet 13. A far infrared heater 6 is provided between the first air outlets 12 and the deodorant and dust filter 15. An ozone generating member 7 is provided between the aroma atomization member 5 and the deodorant and dust filter 15. A negative ion generating member 8 is provided between the ozone generating member 7 and the aroma atomization member 5. An air quality measurement and power control device 4 is provided below the second air outlet 13 and above the ozone generating member 7, the aroma atomization member 5, and the negative ion-generating member 8. The air quality measurement and power control device 4 is electrically connected to the motor 21 for controlling same. The air quality measurement and power control device 4 is implemented by a gas sensor or a particle sensor. The air quality measurement and power control device 4 is adapted to measure air quality and increase or decrease the operating power of the motor 21 in response to different levels of air quality being measured. That is, the motor 21 can operate in one of a plurality of different stages during operation. As a result, power is saved while best air quality is still obtained in operation.

As the motor 21 operates, it draws air to be filtered into the cabinet 1 through the air inlets 11. An air filtering path in the cabinet 1 is as follows. Large solid particles (e.g., hair, fur, or the like) in the air are then removed by the purifying filter 14. Then deodorant and dust filter 15 destroys undesired odors in the air and removes fine particles suspended in the air. Next, the aroma atomization member 5 atomizes liquid aroma and shoot out a fine spray into the air. At the same time, the ozone generating member 7 operates to enhance the germicidal effect. Also, the negative ion generating member 8 removes particulates, pollen, mold, or the like from the air. The far infrared heater 6 emits infrared rays in the filtered air which then exits from the first and second air outlets 12 and 13.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An air filtering device comprising:
a cabinet substantially divided into a lower casing and an upper casing
air inlet means mounted in the lower casing and having one or more openings;
air outlet means mounted in the upper casing and having one or more openings;
air quality measurement and power control means;
an electric fan mounted in a rear of the air inlet means and controlled by the air quality measurement and power control means;
a housing in the lower casing for enclosing the fan and having two sidewalls formed with the sides of the lower casing, the housing including an air intake of streamline section mounted on a front face of the housing, an air exit of rectangular section mounted on an upper portion of the housing, and a top board extended forward from a top of the air exit to a joining side of the upper and lower casing;
one or more ultraviolet lamps mounted on the top of the air exit; and
a deodorant and dust filter mounted in the upper casing,
wherein the fan is adapted to automatically operate in one of a plurality of different stages in response to different levels of air quality measured by the air quality measurement and power control means.

2. The air filtering device of claim 1, wherein each opening of each of the air inlet means and the air outlet means has a louver.

3. The air filtering device of claim 2, further comprising a drive assembly including an electric motor mounted on the cabinet, a link having one end pivotably connected to a rotating shaft of the motor, and a T-shaped member having a projecting portion pivotably connected to the other end of the link and a base portion pivotably connected to the louver.

4. The air filtering device of claim 1, further comprising a purifying filter mounted between the air inlet means and the housing.

5. The air filtering device of claim 1, further comprising a control panel mounted on the cabinet, and a sliding cover having both sides fitted into two parallel grooves of the cabinet, each groove having a predetermined length, the sliding cover adapted to either close the control panel in an inoperative condition or open same in an operating condition.

6. The air filtering device of claim 1, wherein the air quality measurement and power control means is either a gas sensor or a particle sensor.

7. The air filtering device of claim 1, further comprising at least one of a far infrared heater, an ozone generating member, and a negative ion generating member mounted in the air outlet means.

8. The air filtering device of claim 1, further comprising an aroma atomization member mounted on a top of the air outlet means.

9. The air filtering device of claim 5, wherein the control panel includes a display for showing operating states.

10. The air filter device of claim 1, further comprising two or more wheels mounted on a bottom of the cabinet.
